(19) United States
(12) Patent Application Publication
(10) Pub. No.: US 2023/0307758 A1
(43) Pub. Date: Sep. 28, 2023

(54) TRACTION BATTERY PACK ENCLOSURE AND TRACTION BATTERY PACK ASSEMBLY METHOD

(71) Applicant: Ford Global Technologies, LLC, Dearborn, MI (US)

(72) Inventors: Jason C. Marcath, Dearborn, MI (US); Vladimir Vladimirovich Bogachuk, West Bloomfield, MI (US); Robert Reiners, Ypsilanti, MI (US); Karen Siler, Commerce Township, MI (US)

(21) Appl. No.: 17/892,225

(22) Filed: Aug. 22, 2022

Related U.S. Application Data
(60) Provisional application No. 63/322,766, filed on Mar. 23, 2022.

(51) Int. Cl. H01M 50/209; H01M 10/04; H01M 50/119

(52) U.S. Cl. CPC H01M 50/209; H01M 10/0481; H01M 50/119; H01M 2220/20

(57) ABSTRACT

A traction battery pack assembly includes a cell stack disposed along a cell stack axis. A sheet metal enclosure structure holds the cell stack within a cell-receiving area and compresses the cell stack along the cell stack axis. A battery pack assembly method includes forming a sheet metal blank into an enclosure structure having a cell-receiving area, inserting a cell stack into the cell-receiving area of the enclosure structure, and, after the inserting, compressing the cell stack with the enclosure structure.

### CROSS-REFERENCE TO RELATED APPLICATIONS

This application claims priority to United States Provisional Application No. 63/322766, which was filed on 23 Mar. 2022 and is incorporated herein by reference

### TECHNICAL FIELD

This disclosure relates generally to a method of assembling a traction battery pack and, more particularly, to how cell stacks are moved into an enclosure of the battery pack.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. The traction battery pack assembly of an electrified vehicle can include groups of battery cells.

### SUMMARY

In some aspects, the techniques described herein relate to a traction battery pack assembly, including: a cell stack disposed along a cell stack axis; a sheet metal enclosure structure that holds the cell stack within a cell-receiving area and compresses the cell stack along the respective cell stack axis.

In some aspects, the techniques described herein relate to a traction battery pack assembly, wherein the sheet metal enclosure structure is a stamped sheet metal enclosure structure.

In some aspects, the techniques described herein relate to a traction battery pack assembly, wherein the enclosure structure is an enclosure tray.

In some aspects, the techniques described herein relate to a traction battery pack assembly, further including at least one load plate of the cell stack, the at least one load plate having chamfered leading edge.

In some aspects, the techniques described herein relate to a traction battery pack assembly, wherein the at least one load plate includes a first load plate at a first axial end of the cell stack and a second load plate at an opposite second axial end of the cell stack.

In some aspects, the techniques described herein relate to a traction battery pack assembly, wherein the first load plate and the second load plate directly contact the enclosure structure.

In some aspects, the techniques described herein relate to a traction battery pack assembly, wherein the sheet metal enclosure structure circumferentially surrounds the cell stack.

In some aspects, the techniques described herein relate to a traction battery pack assembly, wherein the sheet metal is a metal alloy.

In some aspects, the techniques described herein relate to a traction battery pack assembly, further including at least one wedge disposed between a wall of the sheet metal enclosure structure and the cell stack.

In some aspects, the techniques described herein relate to a traction battery pack assembly, the cell stack is a first cell stack and further including at least one second cell stack held within the cell-receiving area of the sheet metal enclosure structure and compressed along a respective cell stack axis. In some aspects, the techniques described herein relate to a method, further including inserting the cell stack into the cell-receiving area using a compressing machine.

In some aspects, the techniques described herein relate to a battery pack assembly method, including: forming a sheet metal blank into an enclosure structure having a cell-receiving area; inserting a cell stack into the cell-receiving area of the enclosure structure; and after the inserting, compressing the cell stack with the enclosure structure.

In some aspects, the techniques described herein relate to a method, compressing the cell stack with the compressing machine during the inserting.

In some aspects, the techniques described herein relate to a method, wherein the compressing includes compressing the cell stack along a cell stack axis.

In some aspects, the techniques described herein relate to a method, wherein the inserting moves the cell stack relative to the enclosure structure in a direction that is perpendicular to the cell stack axis.

In some aspects, the techniques described herein relate to a method, further including filling a gap between the enclosure structure and the cell stack with at least one wedge.

In some aspects, the techniques described herein relate to a method, further including compressing the cell stack with the at least one wedge sandwiched between the enclosure structure and the cell stack.

In some aspects, the techniques described herein relate to a method, wherein the forming is stamping.

In some aspects, the techniques described herein relate to a method, wherein the sheet metal is a metal alloy.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates a partially expanded view of a traction battery pack from the electrified vehicle of FIG. 1.

FIG. 3 illustrates a press and sheet metal blank prior to a forming operation.

FIG. 4 illustrates the press and sheet metal blank after the forming operation.

FIG. 5 illustrates a close-up view of Area 5 in FIG. 2.

FIG. 6 illustrates a section view taken at line 6-6 in FIG. 5.

FIG. 7 illustrates a group of cells being compressed to provide a cell stack for the traction battery pack of FIG. 2.

FIG. 8 illustrates the group of cells of FIG. 7 compressed and providing the cell stack.

FIG. 9 illustrates a perspective view of a compressing machine engaged with the cell stack of FIG. 8 for insertion of the cell stack into an enclosure structure of the traction battery pack.

FIG. 10 illustrates a perspective view of a pusher of the compressing machine inserting the cell stack of FIG. 8 into the enclosure structure of the traction battery pack.

### DETAILED DESCRIPTION

This disclosure details example traction battery pack assemblies having an enclosure that provides an interior area. Battery cells and electronic modules can be held within the interior area along with other components. The battery cells can be used to power an electric machine.

In particular, this disclosure details exemplary assemblies and methods involving a sheet metal enclosure that compresses the battery cells of a battery pack.

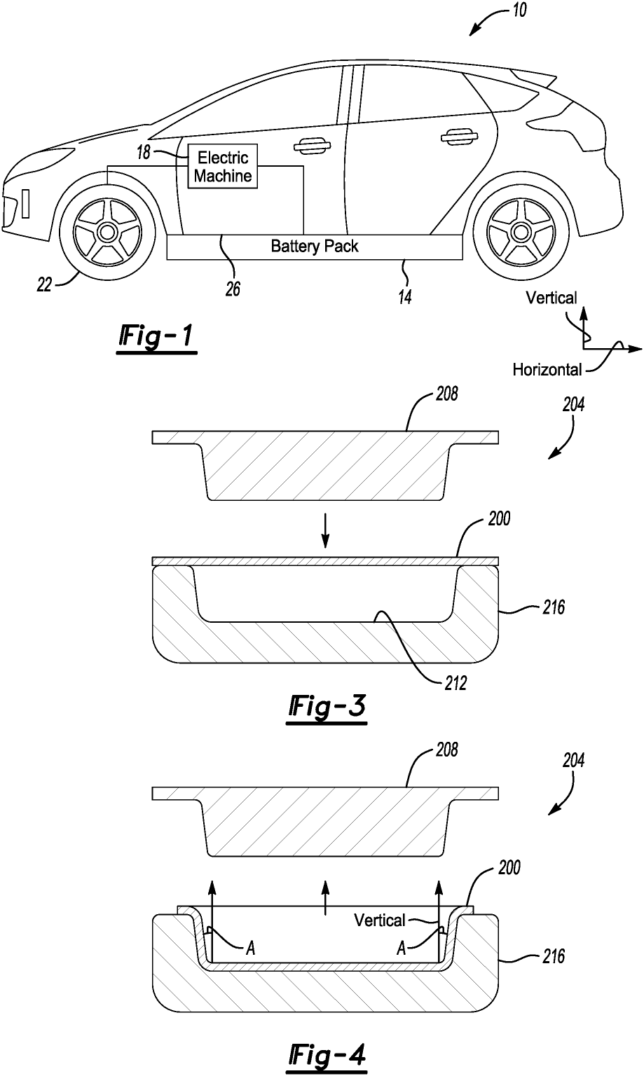

With reference to FIG. 1, an electrified vehicle 10 includes a traction battery pack assembly 14, an electric machine 18, and wheels 22. The traction battery pack assembly 14 powers an electric machine 18, which can convert electrical power to mechanical power to drive the wheels 22. The traction battery pack assembly 14 can be a relatively high-voltage battery.

The traction battery pack assembly 14 is, in the exemplary embodiment, secured to an underbody 26 of the electrified vehicle 10. The traction battery pack assembly 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

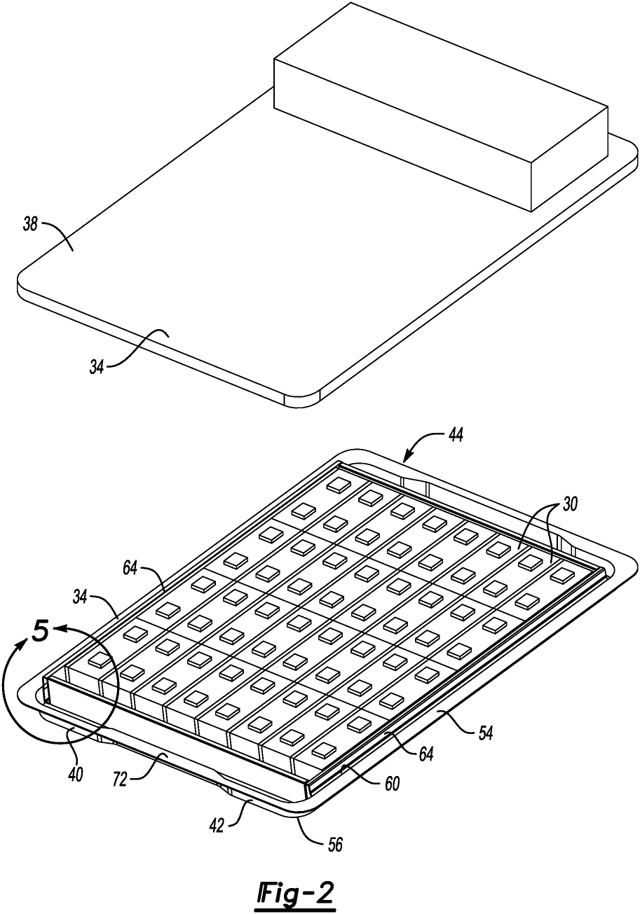

With reference now to FIG. 2, the traction battery pack assembly 14 includes a plurality of battery cells 30 held within an enclosure assembly 34. In the exemplary embodiment, the enclosure assembly 34 comprises various enclosure structures. In particular, the example enclosure assembly 34 includes an enclosure cover 38, an enclosure halo 40, and an enclosure floor 42. The enclosure cover 38, enclosure halo 40, and enclosure floor 42 are secured together to provide an interior area 44 that houses the plurality of battery cells 30.

The plurality of battery cells (or simply, “cells”) 30 are for supplying electrical power to various components of the electrified vehicle 10. The battery cells 30 are stacked side-by-side relative to one another to construct one of a plurality of cell stacks 46, which are positioned side-by-side to provide a cell matrix 50. In this example, each cell stack 46 includes eight individual battery cells 30, and the cell matrix 50 includes four cell stacks 46.

Although a specific number of battery cells 30 and cell stacks 46 are illustrated in the various embodiments of this disclosure, the traction battery pack assembly 14 could include any number of cells 30 and cell stacks 46. In some examples, using an even quantity of battery cells 30 and an even quantity of cell stacks 46 can help to support and efficient electrical bussing arrangement. In other words, this disclosure is not limited to the specific configuration of cells 30 shown in FIG. 2.

In an embodiment, the battery cells 30 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

The enclosure halo 40 and enclosure floor 42 are, in this example, parts of an enclosure tray 54. In particular, the enclosure halo 40 is provided by a plurality of side walls 56 of the enclosure tray 54. The side walls 56 are arranged relative to one another to provide a cell-receiving area 60. The side walls 56 can extend vertically upward from the enclosure floor 42.

The enclosure tray 54 is a sheet metal enclosure structure. As shown in FIG. 3, the enclosure tray 54 can be formed by stamping a sheet metal blank 200 within a press 204. The sheet metal blank 200 can be a metal or metal alloy.

To form the enclosure tray 54, a tool 208 stamps the blank 200 into a die cavity 212 of a die 216. The tool 208 is then withdrawn leaving the enclosure tray 54 within the die cavity 212 as shown in FIG. 4.

The side walls 56 of the tray 54 are angled A from a vertical axis. The angle A is a draft angle that helps to facilitate removing the tray 54 from the die 216.

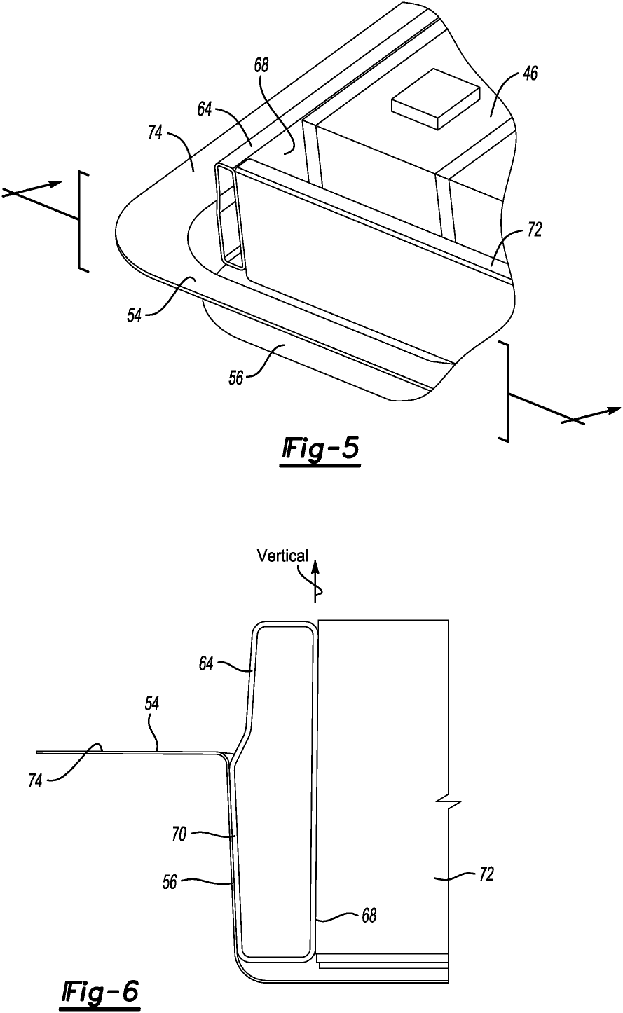

Referring now to FIGS. 2, 5, and 6, a plurality of wedges 64 are used within the tray 54. The wedges 64 are sandwiched between the side walls 56 and the cell stacks 46. In this example, one if the wedges 64 is disposed alongside first axial ends of the cell stacks 46, and another of the wedges 64 is disposed alongside opposite second axial ends of the cell stacks 46. The wedges 64 fill a gap between the cell stacks 46 and the side walls 56 thereby compensating for the angle A.

In particular, an inner side 68 of the wedges 64 interfaces directly with the cell stacks 46 and is, in this example, disposed along a vertical plane. An outer side 70 of the wedges 58 includes an area that angled relative to a vertical plane. This area directly contacts the side walls 56 of the tray 54.

The wedges 64 can be extruded. The wedges 64 can be secured to the tray 54 using bolts or welds, for example. The wedges 64 have a wedge-shaped cross-section.

The tray 54, in this example, also houses a pair of extruded cross-members 72. The extruded cross-members 72 can help to maintain a desired distance between the wedges 64.

When the traction battery pack assembly 14 is assembled, the enclosure cover 38 can be secured to a flange 74 of the tray 54. An interface between the enclosure cover 38 and flange 74 extends circumferentially continuously about the interior area 44. Mechanical fasteners or welds, for example, can be used to secure the enclosure cover 38 and the flange 74. Vertical, for purposes of this disclosure, is with reference to ground and a general orientation of the electrified vehicle 10 during operation.

When the traction battery pack assembly 14 is assembled, the cell matrix 50 is positioned within the cell-receiving area 60. The example enclosure halo 40 includes one cell-receiving area 60, but it should be understood that this disclosure also extends to enclosure assemblies providing more than one cell-receiving area. The enclosure cover 38 can cover the cell matrix 50 within the cell-receiving area 60 to substantially surround the cells 30 from all sides.

The enclosure halo 40 provide by the side walls 56 compresses and holds the cell matrix 50 when the cell matrix 50 is inserted into the cell-receiving area 60 of the enclosure halo 40. In this example, the side walls 56 of the enclosure halo 40 apply forces to the cell matrix 50 when the cell matrix 50 is positioned within the cell-receiving area 60. The wedges 64 adapt the cell-receiving area 60 so that the compressive force from the side walls 56 is passed to the cell stacks 46 through a vertical interface.

The traction battery pack assembly 14 can be considered a cell-to-pack battery assembly. Unlike conventional traction battery pack battery assemblies, a cell-to-pack battery assembly incorporates battery cells or other energy storage devices into the enclosure assembly 34 without the cells being arranged in arrays or modules. The enclosure assembly 34 applies compressive forces to the cells. The cell-to-pack battery assembly may therefore eliminate most, if not all, of the array support structures used in conventional battery arrays (e.g., array frames, spacers, rails, walls, endplates, bindings, etc.) that are used to group and hold the battery cells within the arrays/modules.

The cell matrix 50 comprises a plurality of separate cell stacks 46, which can be separately inserted into the cell-receiving area of the enclosure halo 40. To insert the example cells stacks 46, the cell stacks 46 are, while compressed, moved into place in the cell-receiving area 60. Spacers may be used to maintain spacing between the different cell stacks 46.

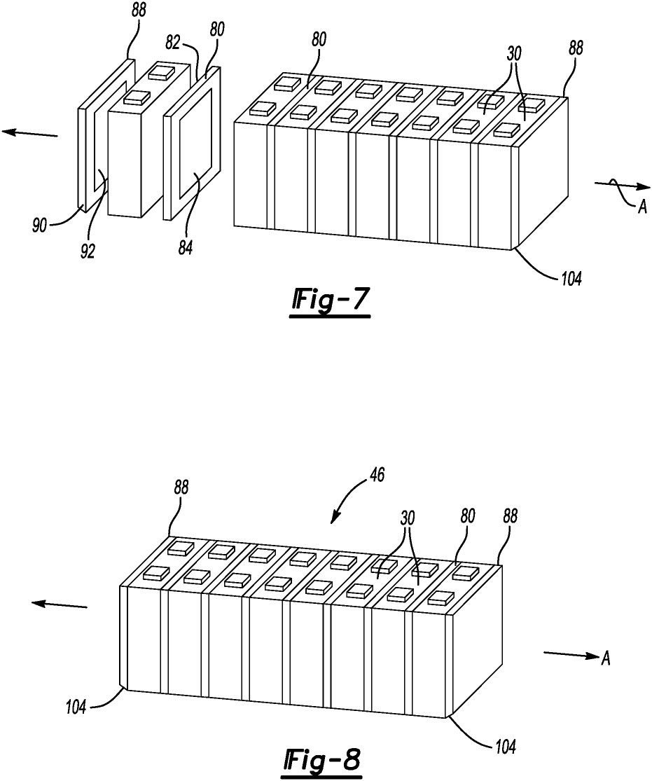

An exemplary method of assembling the traction battery pack assembly 14 will now be explained in connection with FIGS. 7-10.

First, a group of cells 30 is compressed along a cell stack axis A as shown in FIG. 7 to provide one of the cell stacks 46 as shown in FIG. 8. A compression fixture could be used to compress the cells. A pneumatic actuator, for example, could drive the compression fixture to compress the cells 30 along the cell stack axis A. The compressive force exerted on the cells 30 can be 3 kilonewtons in some examples.

In this example, within the cells stacks 46, separator plates 80 are disposed between each of the cells 30 along the cell stack axis A. The separator plates 80 can include a frame portion 82 that holds a compressible material 84. The compressible material 84 can compress to permit some expansion of the cells 30 when installed with the traction battery pack assembly 14. The compressible material 84 can be foam.

Opposing axial ends of each of the cell stacks 46 includes load plates 88. The load plates 88 include a frame portion 90 that holds a compressible material 92. The compressible material 92 can be foam. The compressible material 92 can compress to permit some expansion of the cells 30. In some examples, the load plates 88 omit the compressible material 92.

Next, as shown in FIG. 9, the cell stack 46 is grasped by a compression machine 94 and removed from the compression fixture. The compression machine 94, in this example, maintains the compression of the cell stack 46. In some examples, the compression machine 94 is responsible for compressing the group of cells 30 to provide the cell stack 46. In other examples, like here, the compression machine 94 grasps the cell stack 46 that was already compressed by a compression fixture.

The example compression machine 94 is a 7-axis device, but other types of compression and insertion machinery could be used. The example compression machine includes a pair of first prongs 96 and a pair of second prongs 98. While two first prongs 96 and two second prongs 98 are shown in this example, other examples could include one first prong and one second prong, or more than two first prongs and second prongs.

The compression machine 94 can move the first prongs 96 and the second prongs 98 back-and-forth relative to each other along an axis D to selectively increase or decrease a distance between the first prongs 96 and the second prongs 98.

To hold the cell stack 46, the first prongs 96 and the second prongs 98 are each placed alongside a respective one of the load plates 88. The first prongs 96 and the second prongs 98 are then moved closer together against the respective one of the load plates 88 to grasp the cell stack 46. The compression machine 94 then moves to align the cell stack 46 for insertion into the cell-receiving area 60 of the tray 54 as shown in FIG. 9.

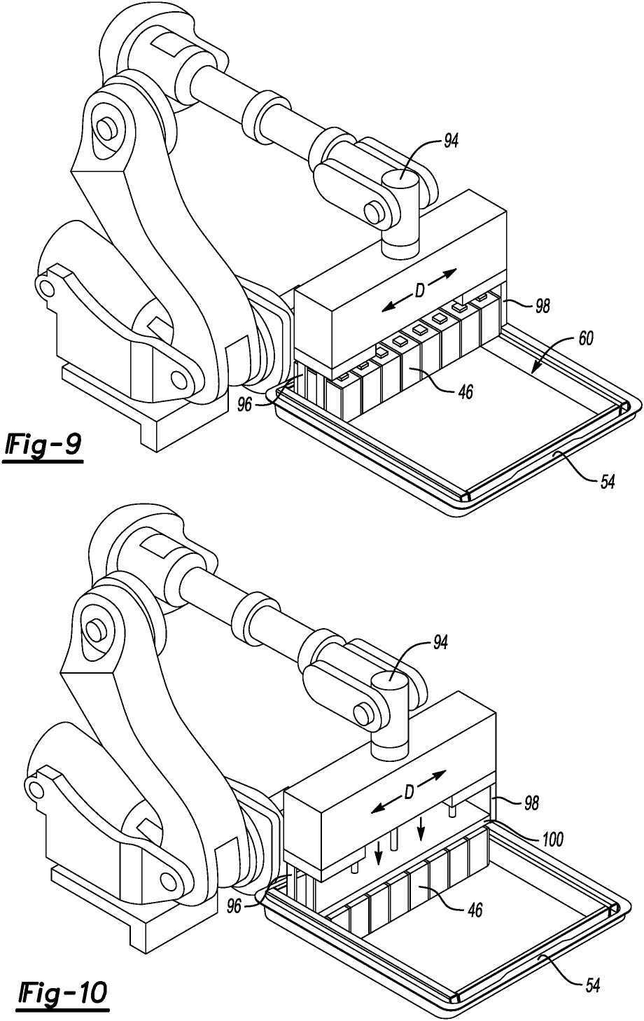

Next, as shown in FIG. 10, a pusher 100 of the compression machine 94 is transitioned from a retracted position to an extended position. Extending the pusher 100 slides the cell stack 46 relative to the first prong 96 and the second prong 98 and pushes the cell stack 46 into an installed position within the cell-receiving area 60. The load plates 88 of the cell stack 46 slide relative to the first prong 96 and the second prong 98 when pushed by the pusher 100. In this example, the cell stack 46 is pushed and inserted into the cell-receiving area 60 in a direction that is perpendicular to the axis A of the cell stack. The load plates 88 can include a chamfered leading edge 104 (FIG. 8), which can contact the wedges 64 during insertion and help to guide insertion of the cell stack 46 into the cell-receiving area 60 between the wedges 64.

The remaining cell stacks 46 of the matrix 50 are installed in a similar manner. The enclosure cover 38 can be secured to the enclosure tray 54 after the cell stacks 46 and other components, such as busbars, are positioned within the enclosure tray 54. The enclosure cover 38 can be secured using mechanical fasteners, for example. The traction battery pack assembly 14 can then be installed into the electrified vehicle 10 of FIG. 1.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
a cell stack disposed along a cell stack axis;
a sheet metal enclosure structure that holds the cell stack within a cell-receiving area and compresses the cell stack along the cell stack axis.

2. The traction battery pack assembly of claim 1, wherein the sheet metal enclosure structure is a stamped sheet metal enclosure structure.

3. The traction battery pack assembly of claim 1, wherein the enclosure structure is an enclosure tray.

4. The traction battery pack assembly of claim 1, further comprising at least one load plate of the cell stack, the at least one load plate having chamfered leading edge.

5. The traction battery pack assembly of claim 4, wherein the at least one load plate includes a first load plate at a first axial end of the cell stack and a second load plate at an opposite second axial end of the cell stack.

6. The traction battery pack assembly of claim 5, wherein the first load plate and the second load plate directly contact the enclosure structure.

7. The traction battery pack assembly of claim 1, wherein the sheet metal enclosure structure circumferentially surrounds the cell stack.

8. The traction battery pack assembly of claim 1, wherein the sheet metal is a metal alloy.

9. The traction battery pack assembly of claim 1, further comprising at least one wedge disposed between a wall of the sheet metal enclosure structure and the cell stack.

10. The traction battery pack assembly of claim 1, wherein the cell stack is a first cell stack and further comprising at least one second cell stack held within the cell-receiving area of the sheet metal enclosure structure and compressed along a respective cell stack axis.

11. A battery pack assembly method, comprising:
forming a sheet metal blank into an enclosure structure having a cell-receiving area;
inserting a cell stack into the cell-receiving area of the enclosure structure; and
after the inserting, compressing the cell stack with the enclosure structure.

12. The method of claim 11, further comprising inserting the cell stack into the cell-receiving area using a compressing machine.

13. The method of claim 12, compressing the cell stack with the compressing machine during the inserting.

14. The method of claim 11, wherein the compressing includes compressing the cell stack along a cell stack axis.

15. The method of claim 14, wherein the inserting moves the cell stack relative to the enclosure structure in a direction that is perpendicular to the cell stack axis.

16. The method of claim 11, further comprising filling a gap between the enclosure structure and the cell stack with at least one wedge.

17. The method of claim 16, further comprising compressing the cell stack with the at least one wedge sandwiched between the enclosure structure and the cell stack.

18. The method of claim 11, wherein the forming is stamping.

19. The method of claim 11, wherein the sheet metal is a metal alloy.
